(19) United States
(12) Patent Application Publication
(10) Pub. No.: US 2011/0221794 A1
(43) Pub. Date: Sep. 15, 2011

(54) Electrophoresis display device and driving method thereof

(76) Inventors: Doyeon Kim, Suwon-si (KR); Suncheol Kwon, Yongin-si (KR); Kyungheon Noh, Suwon-si (KR); Byeongjun Lee, Seongnam-si (KR)

(21) Appl. No.: 13/064,240

(22) Filed: Mar. 14, 2011

(30) Foreign Application Priority Data
Mar. 15, 2010 (KR) 10-2010-0022925

(51) Int. Cl. G09G 5/10; G09G 5/00; G09G 3/34

(52) U.S. Cl. 345/690; 345/204; 345/107; 345/107

(57) ABSTRACT

Provided are an electrophoresis display device and a driving method thereof. The electrophoresis display device includes a display unit and a frame buffer-free display controller. The frame buffer-free display controller is configured to generate a plurality of derived frames in real-time based on a frame and a plurality of reference values displayed by the display unit.

### CROSS-REFERENCE TO RELATED APPLICATIONS

This U.S. non-provisional patent application claims priority under 35 U.S.C. §119 of Korean Patent Application No. 10-2010-0022925, filed on Mar. 15, 2010, the entire contents of which are hereby incorporated by reference.

### BACKGROUND

1. Field

The present disclosure herein relates to a display device, and more particularly, to an electrophoresis display device and a method of driving the same.

2. Description of the Related Art

Paper has high reflectance (about 65%) and a high contrast ratio (about 20:1), e.g., functioning as a display, which allow paper to be visible under ambient light. Also, paper has excellent viewing angle, weight, and durability, and does not require power consumption. On the other hand, paper has a limitation in that it is impossible to freely change contents thereon. Accordingly, although slight visibility-complementary power (enough to operate by a battery) is required, researchers hope to provide electronic papers with electronic functions enabling receipt of information, as well as reading or writing the received information, while features such as excellent reflectance, contrast ratio, viewing angle, flexibility, and durability are maintained.

A method of implementing electronic papers may be classified into approaches from displays and approaches from papers. The former includes a manner in which a display panel is configured, e.g., a frame of a display panel may be configured to be a flexible display panel. For example, the display panel may be formed of plastic, thin glass, or metal plate to allow a basic display, e.g., a liquid crystal display (LCD) or an organic electroluminescent (EL) display, to have flexibility.

On the other hand, examples of approaches from papers may include a manner in which a visual resemblance of an electronic paper to a printed paper may be achieved. For example, a microcapsule method and/or a microcup method, e.g., balls or capsules having sizes of about 0.1 mm or less resembling very tiny ink droplets in printed matter, may be used. In addition to the above manners, a manner of selectively absorbing or reflecting a chip by applying Micro Electro Mechanical System (MEMS) structures may also be applied.

### SUMMARY

Embodiments are therefore directed to an electrophoresis display device and a method of driving the same, which substantially overcome one or more of the problems due to the limitations and disadvantages of the related art.

It is therefore a feature of an embodiment to provide an electrophoresis display device and a driving method thereof, which can express grayscale without using a frame buffer.

At least one of the above and other features and advantages may be realized by providing an electrophoresis display device, including a display unit, and a frame buffer-free display controller configured to generate a plurality of derived frames in real-time based on a frame to be displayed by the display unit and on a plurality of reference values.

The controller may be configured to generate the plurality of derived frames sequentially by comparing values of each pixel data of the frame to be displayed with the plurality of respective reference values. The controller may include a plurality of comparators corresponding to the plurality of reference values, respectively. The reference values of the comparators may be different from each other. The reference values of the comparators may be determined according to one of a random order, an ascending order, and a descending order. The reference values of the comparators may be renewable. At least one of the plurality of comparators may be configured to generate null frame data regardless of the frame to be displayed by the display unit. The controller may further include reserved comparators. A part or all of the reserved comparators may be set to be available according to an external request for changing a grayscale of the display unit, the reserved comparators being set to be available comparators and to generate derived frames in response to the frame to be displayed. The display unit may include a plurality of pixels, each pixel having a microcapsule or a microcup.

At least one of the above and other features and advantages may also be realized by providing an electrophoresis display device, including a display unit having pixels arranged in a matrix pattern defined by a plurality of data lines and a plurality of gate lines, each of the pixels including an electrophoresis element, a dithering unit configured to dither source data, and a comparing unit including a plurality of reference values, the comparing unit being configured to generate a plurality of derived frames to be provided to the display unit in real-time by comparing the dithered data with the reference values.

The comparing unit may include a plurality of comparators, the comparators corresponding to the reference values and including reserved comparators and available comparators, each of the available comparators being configured to determine whether the corresponding reference value is identical to or greater than a value of each pixel data in the dithered data and to output high/low data as a determination result. The available comparators may be sequentially activated to sequentially generate the derived frames. The reference values of the reserved and available comparators may be different from each other. The electrophoresis display device may further include a control unit configured to set all or a part of the reserved comparators as available comparators in response to an external request for changing a grayscale of the display unit. At least one of the available comparators may be configured to generate null frame data regardless of a frame to be displayed by the display unit. The display unit may include a voltage generator configured to generate one or more driving voltage sets to be provided to the data lines according to an output of the comparing unit, each of the driving voltage sets including a positive voltage, a negative voltage, and a fixed voltage, which are supplied to the data line. At least one of the driving voltage sets may be selectively generated according to a temperature of the electrophoresis display device.

At least one of the above and other features and advantages may also be realized by providing a method of driving an electrophoresis display device, the method including dithering frame data to be delivered to a display unit having pixels arranged in a matrix pattern defined by a plurality of data lines and a plurality of gate lines, generating a plurality of derived frames to be provided to the display unit in real-time by comparing the dithered frame data with a plurality of respective reference values, and driving data lines of the display unit based on the derived frames. Generating the plurality of derived frames may include generating at least one null data frame.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a block diagram of an electrophoresis display device according to an exemplary embodiment of the inventive concept;

FIG. 2 illustrates a block diagram of a display unit shown in FIG. 1;

FIGS. 3A and 3B illustrate schematic cross-sectional views of an electrophoresis panel assembly according to exemplary embodiments of the inventive concept;

FIG. 4 illustrates a block diagram of a controller according to an exemplary embodiment of the inventive concept;

FIG. 5 illustrates a block diagram of a comparing unit shown in FIG. 4 according to exemplary embodiments of the inventive concept;

FIG. 6 illustrates a diagram of a correlation between reference values of comparators pertaining to a comparing unit and dithered data according to an exemplary embodiment of the inventive concept;

FIG. 7 illustrates a diagram of an operation of an electrophoresis display device according to an exemplary embodiment of the inventive concept;

FIG. 8 illustrates a diagram of a change of electric charges of a microcapsule according to a driving voltage of a data line;

FIG. 9 illustrates a block diagram of a comparing unit according to other embodiments; and

FIG. 10 illustrates a block diagram of a comparing unit according to still other embodiments.

### DETAILED DESCRIPTION

Exemplary embodiments of the inventive concept will be described below in more detail with reference to the accompanying drawings. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art.

In the drawings, Exemplary embodiments of the inventive concept are not limited to specific forms shown in the drawings, and are exaggerated for clarity of illustration. Also, like reference numerals refer to like elements throughout.

As used herein, the term “and/or” includes any and all combinations of one or more of the associated listed items. Also, when one part (or element, device, etc.) is referred to as being “connected/coupled” to another part (or element, device, etc.), it should be understood that the former may be “directly connected” to the latter, or “indirectly connected” to the latter through at least one intervening part (or element, device, etc.). The terms of a singular form may include plural forms unless referred to the contrary. The meaning of “include,” “comprise,” “including,” or “comprising,” specifies a property, a region, a fixed number, a step, a process, an element and/or a component but does not exclude other properties, regions, fixed numbers, steps, processes, elements and/or components.

Hereinafter, exemplary embodiments of the inventive concept will be described in detail with reference to the accompanying drawings.

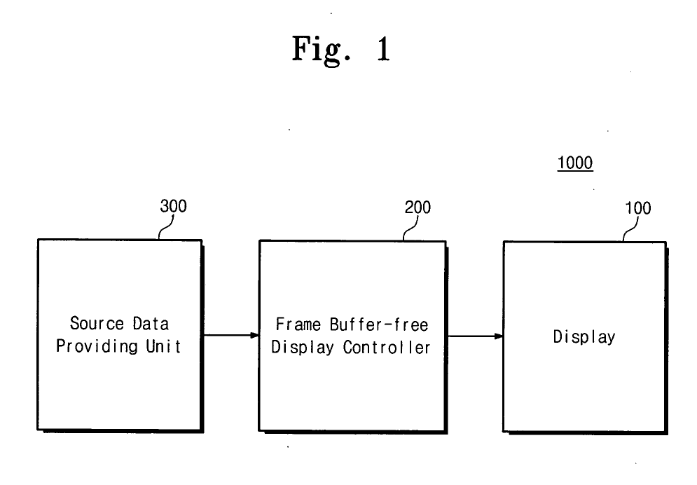

FIG. 1 illustrates a block diagram of an electrophoresis display device according to exemplary embodiments of the inventive concept. Referring to FIG. 1, an electrophoresis display device 1000 according to exemplary embodiments of the inventive concept may include a display unit 100, a controller 200, and a source data providing unit 300.

The display unit 100 may operate in response to control of the controller 200, and may provide display functions. For example, the display unit 100 may be configured to have flexibility.

The controller 200 may be configured to control the display unit 100. The controller 200 may process source data provided from the source data providing unit 300, and may provide the processed data to the display unit 100. The controller 200 may be configured to control grayscale of the display unit 100 with a Frame Rate Control (FRC) method. However, it will be understood that the grayscale control of the controller 200 is not limited to that disclosed herein.

The controller 200 according to example embodiments may not require a frame buffer for storing derived frames (or reference frames) used to implement, in particular, grayscale. That is, the controller 200 may be configured to sequentially generate derived frames in real-time based on the source data provided from the source data providing unit 300, as will be described in detail below.

The source data providing unit 300 may be configured to provide the source data to the controller 200. The source data providing unit 300 may be configured to interface with the outside in a wired and/or wireless manner. The source data providing unit 300 may include a processing unit, a memory, and the like.

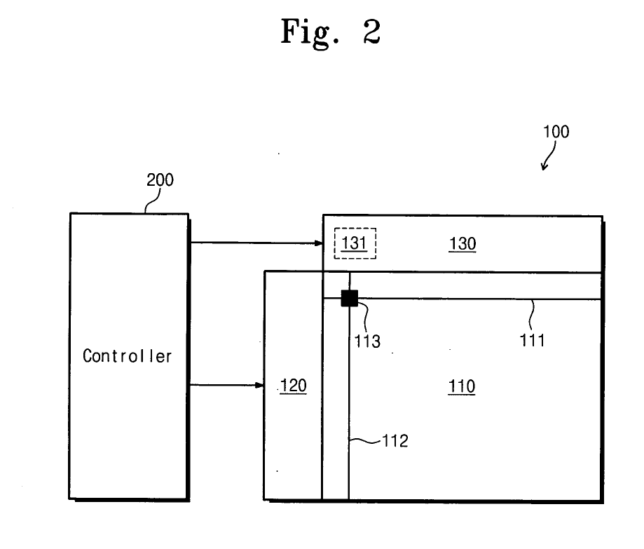

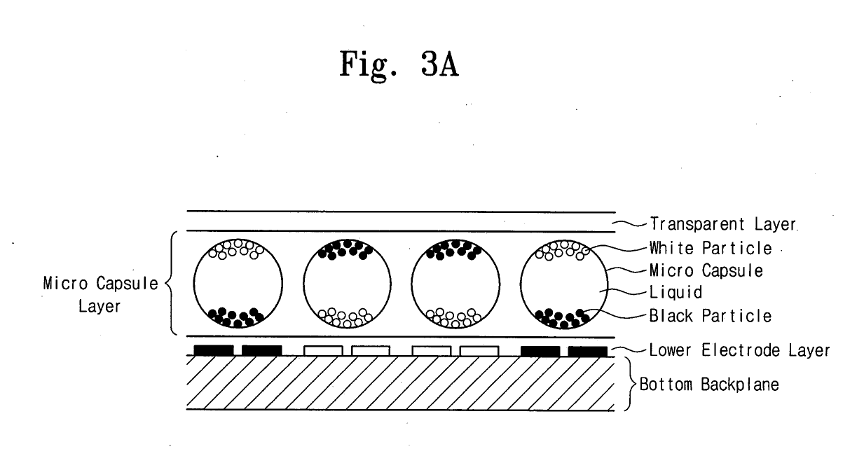

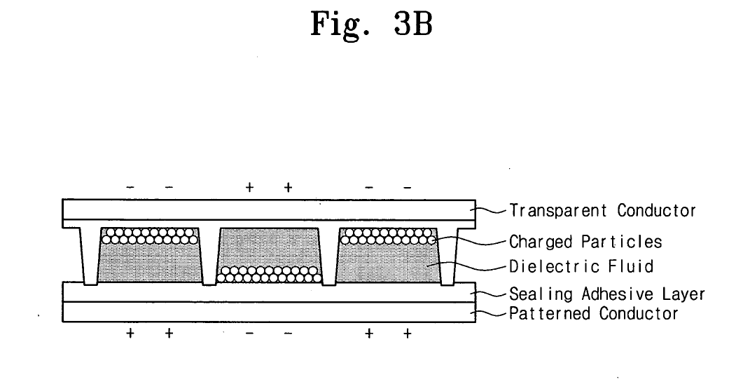

FIG. 2 illustrates a block diagram of the display unit 100, and FIGS. 3A and 3B illustrate partial schematic cross-sectional views of an electrophoresis panel assembly 110 shown in FIG. 2 according to exemplary embodiments of the inventive concept.

Referring to FIG. 2, the display unit 100 may include an electrophoresis panel assembly 110, a gate driving unit 120, and a data driving unit 130. The electrophoresis panel assembly 110 may include a plurality of pixels arranged in a matrix form of a plurality of gate lines and a plurality of data lines. For easy of illustration, one gate line 111, one data line 112, and one pixel 113 are illustrated in FIG. 2. The pixels of the electrophoresis panel assembly 110 may be implemented in various manners. For example, as shown in FIG. 3A, the pixels of the electrophoresis panel assembly 110 may be implemented with electrophoresis device, i.e., elements, having microcapsules. In another example, as shown in FIG. 3B, the pixels of the electrophoresis panel assembly 110 may be implemented with electrophoresis devices having microcups. However, it will be understood that the pixels of the electrophoresis panel assembly 110 are not limited to that disclosed herein. The electrophoresis panel assembly 110 may also be called a pixel array. As understood by persons skilled in the art, the respective pixels of the electrophoresis panel assembly 110 may represent white or black color according to the direction of an electric field formed between a common electrode and a bottom electrode. For example, the bottom electrode may be electrically connected to a data line through a switch controlled by a gate line.

Referring again to FIG. 2, the gate driving unit 120 may be configured to drive the gate lines of the electrophoresis panel assembly 110 in a predetermined manner (e.g., progressive or interlaced scanning) in response to the control of the controller 200. The data driving unit 130 may be configured to drive the data lines of the electrophoresis panel assembly 110 in response to the control of the controller 200. The data driving unit 130 may drive the data lines using one of a plurality of driving voltages according to the data to be provided to the respective pixels. For example, the plurality of driving voltages may include a positive voltage (+), a negative voltage (−), and a ground voltage (0 V) as a fixed voltage. The data driving unit 130 may include a voltage generator 131 generating the plurality of driving voltages.

In an exemplary embodiment, the voltage generator 131 may be configured to generate a plurality of driving voltage sets. One driving voltage set may include a positive voltage, a negative voltage, and a ground voltage as a fixed voltage. The levels of driving voltages pertaining to the respective sets may be different from each other. For example, one of the driving voltage sets may be selected according to the temperature of the electrophoresis display device 1000. For example, the temperature of the electrophoresis display device 1000 may be measured by the controller 200. In another example, the temperature of the electrophoresis display device 1000 may be measured by the display unit 100.

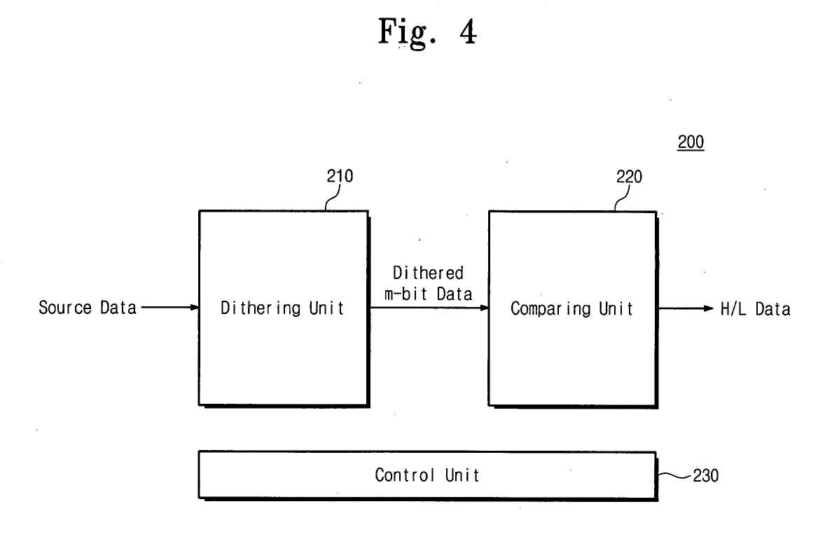

FIG. 4 illustrates a block diagram of the controller 200 according to an exemplary embodiment of the inventive concept. Referring to FIG. 4, the controller 200 according to an exemplary embodiment of the inventive concept may include a dithering unit 210, a comparing unit 220, and a control unit 230.

The dithering unit 210 may convert n-bit data of each pixel provided from the source data providing unit 300 into m-bit data, where n is a positive integer greater than m. The data conversion of the dithering unit 210 may be performed according to special dithering. The data processed by the dithering unit 210 may be provided to the comparing unit 220, i.e., dithered m-bit data. The dithered m-bit data may be temporarily stored in the dithering unit 210, or may be directly provided to the comparing unit 220.

The comparing unit 220 may have a plurality of reference values, and may determine whether each reference value is identical to or greater than the m-bit data dithered by the dithering unit 210. The comparing unit 220 may sequentially output ‘high’ or ‘low’ data according to the determination result. The ‘high’ or ‘low’ data output from the comparing unit 220 may be sequentially provided to the data driving unit 130 of the display unit 100.

The control unit 230 may be configured to control overall operations of the dithering unit 210 and the comparing unit 220. Also, the control unit 230 may control timing of control signals provided to the display unit 100.

According to an exemplary embodiment of the inventive concept, if m-bit data related to each pixel pertaining to a frame processed by the dithering unit 210 is sequentially provided to the comparing unit 220, the comparing unit 220 may generate a series of ‘high’/‘low’ data in real-time based on the respective reference values. One frame (or one derived frame) may be generated by the comparing unit 220 based on one reference value. This means that the comparing unit 220 may generate a plurality of frames (or, a plurality of derived frames) in real-time based on one frame (corresponding to source data) and the plurality of reference values. For this reason, a frame buffer for storing a plurality of such derived frames may not be required in the controller 200, e.g., as compared to conventional art. That is, the controller 200 may be a frame buffer-free display controller.

In an exemplary embodiment, the output of the comparator in the comparing unit 220, i.e., low/high data, may be 2-bit data. The low data may be set to ‘00’, and the high data may be set to ‘01’. However, it will be understood that the low/high data are not limited to that disclosed herein.

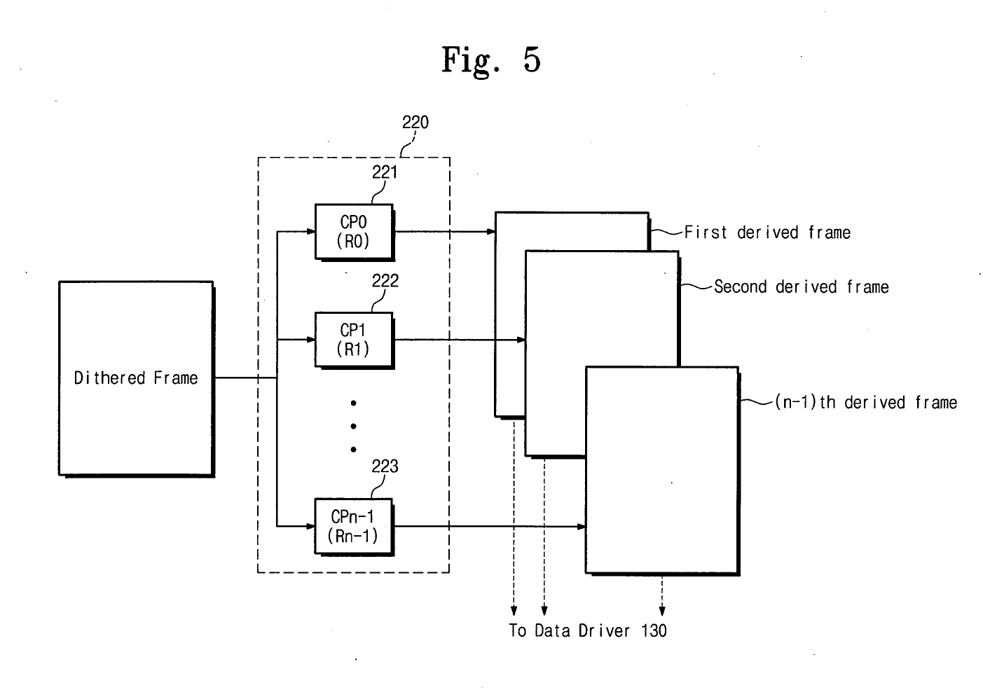

FIG. 5 illustrates a block diagram of the comparing unit 220 shown in FIG. 4 according to exemplary embodiments of the inventive concept. Referring to FIG. 5, the comparing unit 220 may include a plurality of comparators, e.g., comparators 221 to 223. The comparators, e.g., comparators 221 to 223, may be configured to have reference values R0 to Rn−1, respectively. The reference values R0 to Rn−1 of the comparators 221 to 223 may be set different from each other.

The reference values R0 to Rn−1 of the comparators 221 to 223 may be updated by the control of the control unit 230. The comparators 221 to 223 may be sequentially activated according to the control of the control unit 230. The comparator 221 may determine whether corresponding reference values are identical to or greater than m-bit data of each pixel pertaining to a dithered frame. When the corresponding reference value is identical to or greater than the m-bit data of each pixel pertaining to the dithered frame, the comparator 221 may output ‘low’ data. On the other hand, when the corresponding reference value is smaller than the m-bit data of each pixel pertaining to the dithered frame, the comparator 221 may output ‘high’ data. Such a comparison operation may be performed on all pixels pertaining to the dithered frame. Consequently, the comparator 221 may generate one frame (or one derived frame) based on reference values corresponding to the dithered frame data. The other comparators, e.g., comparators 222 to 223, may operate similarly to the comparator 221, and therefore detailed description thereof will be omitted herein.

As apparent from the above description, it may be possible to provide to the data driving unit 130 a series of sequentially derived frames in real-time in accordance with the dithered frame and the reference values R0 to Rn−1 of the comparators 221 to 223 without a frame buffer. In other words, it may be possible to represent grayscale without a frame buffer by providing a series of sequentially derived frames in real-time to the data driving unit 130.

In an exemplary embodiment, the number of comparators pertaining to the comparing unit 220 may be set smaller than the number of grayscales to be represented by 1, and may be identical to the number of necessary derived frames. That is, one derived frame per comparator may be generated through a real-time operation.

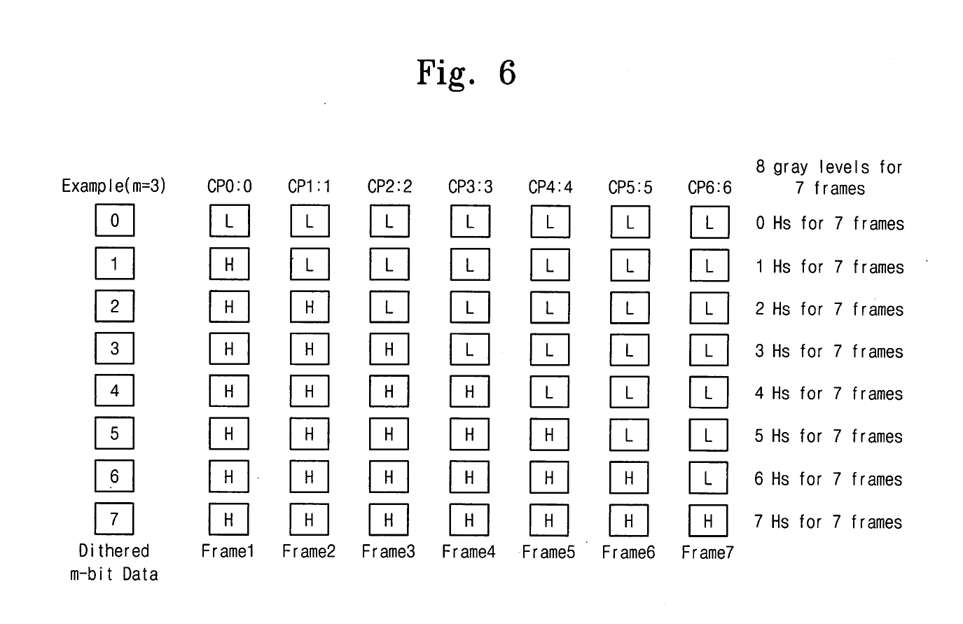

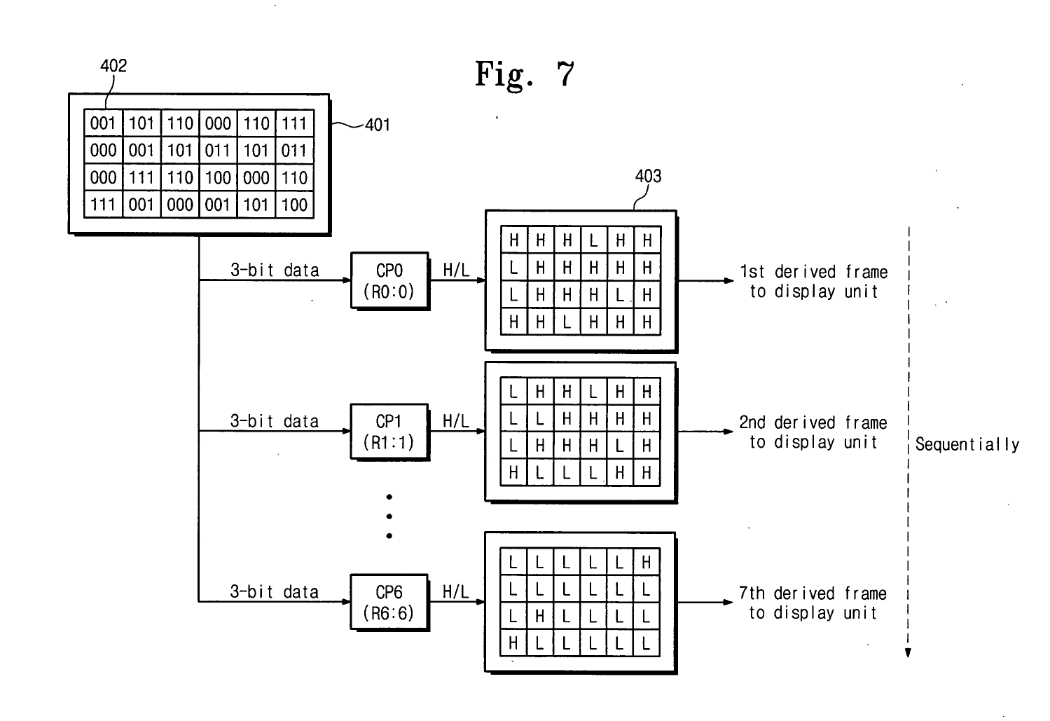

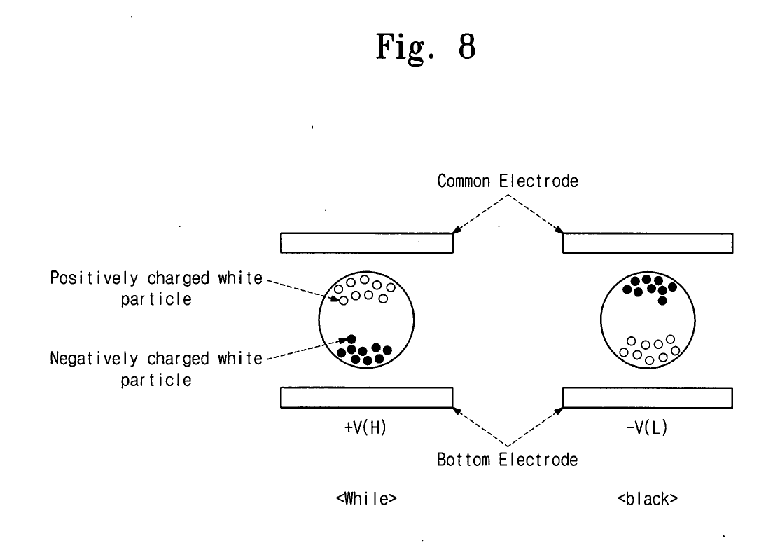

FIG. 6 illustrates a diagram of a correlation between reference values of comparators pertaining to a comparing unit and dithered data according to an exemplary embodiment of the inventive concept. FIG. 7 illustrates a diagram of an operation of an electrophoresis display device according to an exemplary embodiment of the inventive concept. FIG. 8 illustrates a diagram of a change of electric charges of a microcapsule according to a driving voltage of a data line. Hereinafter, an operation of an electrophoresis display device according to an exemplary embodiment of the inventive concept will be described in detail based on the accompanying drawings.

For convenience of explanation, it will be assumed that the number of grayscales to be represented is eight, data of each pixel is 3-bit data, and one frame includes four lines configured with six pixels, respectively. According to the above assumption, as shown in FIG. 7, the comparing unit 220 may be configured with seven comparators CP0 to CP6.

First, the source data providing unit 300 may provide source data to the controller 200. The dithering unit 210 of the controller 200 may convert n-bit data of each pixel provided from the source data providing unit 300 into m-bit data (n is a positive integer greater than m). This operation is called spatial dithering. For convenience of drawing, it will be assumed that data 401 processed by the dithering unit 210, i.e., dithered frame 401, have the same pattern as that shown in FIG. 7.

Next, the data 401 processed by the dithering unit 210 may be provided to the comparator CP0 under the control of the control unit 230. For example, the data 401 processed by the dithering unit 210 may be provided to the comparator CP0 by unit of pixel under the control of the control unit 230. However, it should be understood that the unit of data provided to the comparator CP0 may be variously changed.

Referring to FIG. 7, the reference value R0 of the comparator CP0 is set to ‘0’. The comparator CP0 may determine whether a 3-bit data value (e.g., data of the first pixel) provided from the dithering unit 210 is greater than the reference value R0. As shown in FIG. 7, the data 402 of the first pixel is “001”. Accordingly, since the 3-bit data value (001) of the first pixel provided from the dithering unit 210 is greater than the reference value (R0:0), the comparator CP0 may output ‘high’ data as a determination result. If the pixel data of the dithered frame 401 is sequentially provided to the comparator. CP0, a first derived frame 403 may be generated in real-time as a result.

The generated derived frame 403 may be provided to the data driving unit 130 of the display unit 100 according to the control of the control unit 230. When the output of the comparator is ‘high’ data, the data driving unit 130 may drive a corresponding data line at a positive voltage (+V). This means that, as shown in FIG. 8, positively charged white particles pertaining to a microcapsule are moved to a common electrode, and negatively charged black particles pertaining to the microcapsule are moved to a bottom electrode (driven at a positive voltage (+V) of the data line). In contrast, when the output of the comparator is ‘low’ data, the data driving unit 130 may drive a corresponding data line at a negative voltage (−V). This means that, as shown in FIG. 8, positively charged white particles pertaining to a microcapsule are moved to a bottom electrode (driven at a positive voltage (+V) of the data line), and negatively charged black particles pertaining to the microcapsule are moved to a common electrode.

When the generation of the first derived frame 403 is completed by the comparator CP0, the control unit 230 may activate the comparator CP1 to generate a second derived frame. In this case, the comparator CP0 may be inactivated by the control unit 230. The reference value R1 of the comparator CP1 is set to ‘1’ in FIG. 7. This means that the comparator CP1 outputs ‘high’ data when the pixel data of the dithered frame 401, i.e., the 3-bit data from the dithering unit 210, is greater than the reference value R1. As shown in FIG. 6, the reference values R2 to R6 of the other comparators CP2 to CP6 are set to progressively increase by 1. Similarly to the comparator CP1, the other comparators CP2 to CP6 may generate other derived frames in real-time.

8-level grayscale may be represented by generating consecutively and in real-time seven derived frames using seven comparators regarding one source (or dithered) frame. Mean values of potentials applied to the bottom electrode progressively increase/decrease by varying the high-low frequency of each pixel through seven derived frames. Accordingly, the disposition of white and black particles in a microcapsule/microcup may correspond to the mean value of potential applied to the bottom electrode, thereby enabling various grayscale representations.

In an exemplary embodiment, the operation of the electrophoresis display device 1000 has been described on the assumption that the reference values R0 to R6 of the comparators CP0 to CP6 are set in an ascending order. However, it will be understood that the reference values R0 to R6 of the comparators CP0 to CP6 may be set in a descending order or random manner. In this case, more various combination of driving voltages (or voltages applied to a bottom electrode) is possible.

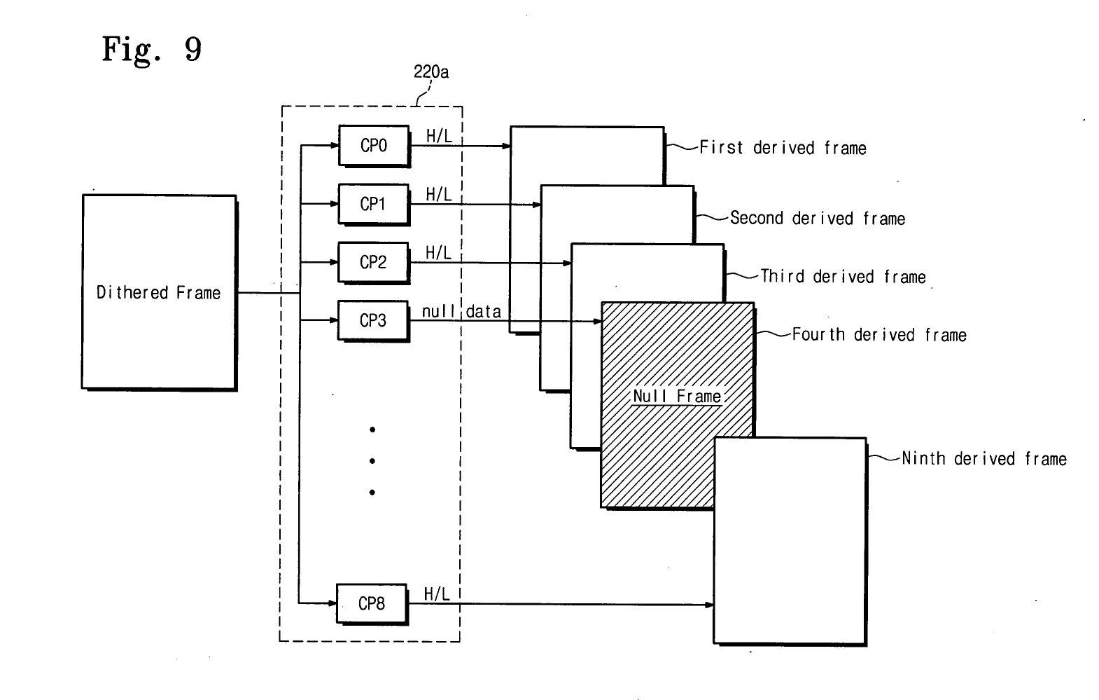

FIG. 9 illustrates a block diagram of a comparing unit according to other embodiments of the inventive concept. Referring to FIG. 9, a comparing unit 220a may include a plurality of comparators CP0 to CP8.

At least one (e.g., CP3) of the comparators CP0 to CP8 may be configured to output null data for applying a voltage of about 0 V as a fixed voltage to a bottom electrode. The null data may be set to, e.g., ‘11’. When a voltage of about 0V is applied to the bottom electrode, the position of particles in a microcapsule/microcup may be maintained at a previous state. A reference value of the comparator CP3 may be set as deviating from a value represented by, for example, data (i.e., m-bit data) of a pixel. When the reference value of the comparator CP3 does not match the data of the pixel, the comparator CP3 may output null data. The comparators other than the comparator CP3 used to generate the null data/frame may operate substantially identically to those described in FIGS. 6 through 8, and therefore detailed description thereof will be omitted herein. In an exemplary embodiment, one or more comparators may be arranged in the comparing unit 220a without a positional limitation to generate null data/frame.

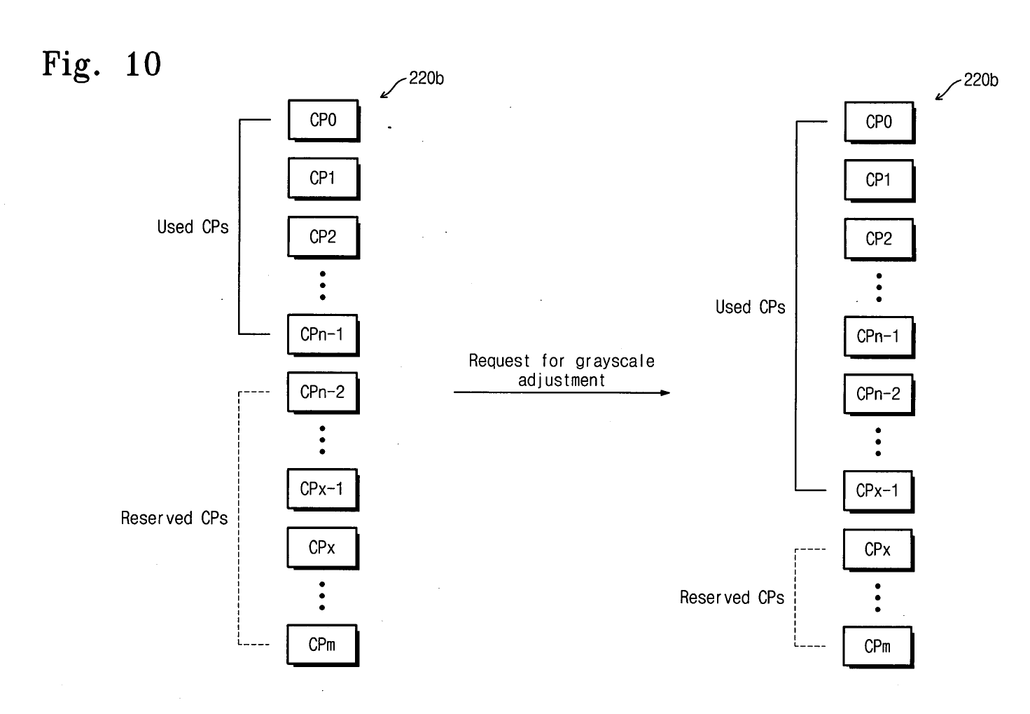

FIG. 10 illustrates a block diagram of a comparing unit according to still other embodiments of the inventive concept. Referring to FIG. 10, a comparing unit 220b may include a plurality of comparators CP0 to CPm.

A part of the comparators CP0 to CPm may be reserved comparators that are not used. When a user intends to change grayscale levels, all or part of the reserved comparators may be used to generate derived frames, respectively. For example, when information is provided from the outside to the source data providing unit 300 for grayscale change, the source data providing unit 300 may control the controller 200 to change the grayscale levels. The control unit 230 of the controller 200 may set all or part of the reserved comparators as available comparators. Reference values of the reserved comparators set as available comparators may also be set by the control unit 230. Alternatively, the reference values of the reserved comparators as available comparators may be programmed in advance. The grayscale change may be performed according to external requests or operation conditions of the electrophoresis display device 1000. At least one of the available comparator may be used to generate null data/frame.

According to exemplary embodiments, it may be possible to generate a plurality of derived frames without using a frame buffer.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. An electrophoresis display device, comprising:
a display unit; and
a frame buffer-free display controller configured to generate a plurality of derived frames in real-time based on a frame to be displayed by the display unit and on a plurality of reference values.

2. The electrophoresis display device as claimed in claim 1, wherein the controller is configured to generate the plurality of derived frames sequentially by comparing values of each pixel data of the frame to be displayed with the plurality of respective reference values.

3. The electrophoresis display device as claimed in claim 2, wherein the controller includes a plurality of comparators corresponding to the plurality of reference values, respectively.

4. The electrophoresis display device as claimed in claim 3, wherein the reference values of the comparators are different from each other.

5. The electrophoresis display device as claimed in claim 3, wherein the reference values of the comparators are determined according to one of a random order, an ascending order, and a descending order.

6. The electrophoresis display device as claimed in claim 3, wherein the reference values of the comparators are renewable.

7. The electrophoresis display device as claimed in claim 3, wherein at least one of the plurality of comparators is configured to generate null frame data regardless of the frame to be displayed by the display unit.

8. The electrophoresis display device as claimed in claim 3, wherein the controller further comprises reserved comparators.

9. The electrophoresis display device as claimed in claim 8, wherein a part or all of the reserved comparators are set to be available according to an external request for changing a grayscale of the display unit, the reserved comparators being set to be available comparators and to generate derived frames in response to the frame to be displayed.

10. The electrophoresis display device as claimed in claim 1, wherein the display unit includes a plurality of pixels, each pixel having a microcapsule or a microcup.

11. An electrophoresis display device, comprising:
a display unit having pixels arranged in a matrix pattern defined by a plurality of data lines and a plurality of gate lines, each of the pixels including an electrophoresis element;
a dithering unit configured to dither source data; and
a comparing unit including a plurality of reference values, the comparing unit being configured to generate a plurality of derived frames to be provided to the display unit in real-time by comparing the dithered data with the reference values.

12. The electrophoresis display device as claimed in claim 11, wherein the comparing unit includes a plurality of comparators, the comparators corresponding to the reference values and including reserved comparators and available comparators, each of the available comparators being configured to determine whether the corresponding reference value is identical to or greater than a value of each pixel data in the dithered data and to output high/low data as a determination result.

13. The electrophoresis display device as claimed in claim 12, wherein the available comparators are sequentially activated to sequentially generate the derived frames.

14. The electrophoresis display device as claimed in claim 13, wherein the reference values of the reserved and available comparators are different from each other.

15. The electrophoresis display device as claimed in claim 12, further comprising a control unit configured to set all or a part of the reserved comparators as available comparators in response to an external request for changing a grayscale of the display unit.

16. The electrophoresis display device as claimed in claim 12, wherein at least one of the available comparators is configured to generate null frame data regardless of a frame to be displayed by the display unit.

17. The electrophoresis display device as claimed in claim 11, wherein the display unit includes a voltage generator configured to generate one or more driving voltage sets to be provided to the data lines according to an output of the comparing unit, each of the driving voltage sets including a positive voltage, a negative voltage, and a fixed voltage, which are supplied to the data line.

18. The electrophoresis display device as claimed in claim 17, wherein at least one of the driving voltage sets is selectively generated according to a temperature of the electrophoresis display device.

19. A method of driving an electrophoresis display device, comprising:
dithering frame data to be delivered to a display unit having pixels arranged in a matrix pattern defined by a plurality of data lines and a plurality of gate lines;
generating a plurality of derived frames to be provided to the display unit in real-time by comparing the dithered frame data with a plurality of respective reference values; and
driving data lines of the display unit based on the derived frames.

20. The method as claimed in'claim 19, wherein generating the plurality of derived frames includes generating at least one null data frame.
